(19) United States
(12) Patent Application Publication
(10) Pub. No.: US 2012/0183642 A1
(43) Pub. Date: Jul. 19, 2012

(54) ADDITION OF ELECTROLYTES TO HUMMINGBIRD FOOD FORMULATIONS

(75) Inventor: Mario Olmos, Fort Worth, TX (US)

(73) Assignee: CENTRAL GARDEN & PET COMPANY, Walnut Creek, CA (US)

(21) Appl. No.: 13/349,943

(22) Filed: Jan. 13, 2012

Related U.S. Application Data
(60) Provisional application No. 61/432,525, filed on Jan. 13, 2011.

(51) Int. Cl. A23K 1/18; A23K 1/175

(52) U.S. Cl. 426/1

(57) ABSTRACT

Inclusion of electrolytes in sucrose/water solutions comprising hummingbird food formulations may reduce dehydration in hummingbirds that feed on these formulations. Potassium and/or sodium bicarbonate are electrolytes that may be added to sucrose/water solutions. Concentrated as well as ready-to-use hummingbird food formulations may be prepared including these electrolytes.

### CROSS-REFERENCE TO RELATED APPLICATIONS

This application claims the benefit of Provisional Application No. 61,432,525, filed on Jan. 13, 2011, entitled “Addition of Electrolytes to Hummingbird Nectar” and is incorporated by reference herein in its entirety.

### FIELD OF THE INVENTION

The disclosure relates generally to reducing dehydration in hummingbirds, and more specifically, to addition of electrolytes to hummingbird food formulations to reduce dehydration in hummingbirds.

### BACKGROUND

Hummingbirds typically feed on nectar, either natural flower nectar or a sucrose/water solution (which may be commercially produced or homemade). In fact, hummingbirds are believed to consume as much as five times their body mass each day in nectar. Hummingbirds quickly process excess water consumed while drinking nectar, which acts to return body mass to pre-feeding status and reduce the ill effects of excess circulating water. However, processing water this rapidly comes at a cost. Electrolytes are lost during excretion, and thus, copious urine production can result in a net loss of electrolytes acting to dehydrate the hummingbird. As such, hummingbirds are predisposed to suffer from dehydration due to their diet.

### SUMMARY

Embodiments of the present disclosure generally provide for addition of electrolytes to sucrose/water solutions to form hummingbird food formulations that reduce dehydration in hummingbirds that feed on these formulations. The electrolytes added to sucrose/water solutions according to embodiments of the present disclosure may typically take the form of potassium and/or sodium bicarbonate. However, it should be appreciated that other electrolytes may be added without departing from the present disclosure.

In an embodiment of the present disclosure, a ready-to-use hummingbird food formulation may include at least one bicarbonate electrolyte added to a sucrose and water solution. Preservatives such as sodium benzoate and/or potassium sorbate also may be incorporated into the formulation along with citric acid.

In another embodiment of the present disclosure, a concentrated hummingbird food formulation may be comprised of electrolytes, including at least one bicarbonate electrolyte, such as potassium and/or sodium bicarbonate. These electrolytes may be added to a sucrose and water solution. Preservatives also may be incorporated into the formulation as well as citric acid.

In a further embodiment of the present disclosure, a method for improving hummingbird hydration may comprise forming a premix of water, at least one bicarbonate electrolyte, at least one preservative, wherein the premix may include approximately 10% of the water comprising the resultant hummingbird food formulation. The premix also may include at least one non-bicarbonate electrolyte. The remainder of the water comprising the resultant hummingbird food formulation may be heated to a first predetermined temperature and then blended with citric acid to form a first mixture. Sucrose may be added to the first mixture to form a second mixture. The second mixture may then be cooled to a second predetermined temperature, and the premix may be added to the second mixture to form a third mixture. The third mixture may be cooled to a third predetermined temperature, thereby forming the resultant hummingbird food formulation having electrolytes to improve hummingbird hydration.

### DETAILED DESCRIPTION

Many people enjoy having hummingbirds visit their backyard feeders, and most backyard feeders are typically filled with sucrose and water solutions, both commercially produced and homemade. However, unlike most natural flower nectars that tend to contain some electrolytes that address the issue of hummingbird dehydration, the typical sucrose and water solutions utilized in backyard feeders lack these electrolytes.

This lack of electrolytes increases the probability of dehydration in hummingbirds that utilize these sucrose/water solutions as a major source of food. Therefore, hummingbird food formulations are disclosed that may provide these needed electrolytes to hummingbirds and reduce the potential for dehydration in hummingbirds consuming these food formulations.

Embodiments of the present disclosure generally provide for addition of electrolytes to a traditional sucrose and water solution typically utilized in backyard feeders to reduce dehydration in hummingbirds. Electrolytes incorporated into hummingbird food formulations according to embodiments of the present disclosure may include potassium bicarbonate and/or sodium bicarbonate. Addition of these electrolytes may provide needed sodium and potassium to hummingbirds, as hummingbirds often have to replace approximately 14% of the sodium and potassium in their bodies each day.

According to an embodiment of the present disclosure, a ready-to-use hummingbird food formulation may include sodium benzoate (in a range of 0 to 0.10% and more preferably approximately 0.05%), potassium sorbate (in a range of 0 to 0.20% and more preferably approximately 0.10%), citric acid (in a range of 0 to 0.80% and more preferably approximately 0.40%), potassium bicarbonate (in a range of 0 to 0.090% and more preferably approximately 0.045%), and sodium bicarbonate (in a range of 0 to 0.150% and more preferably approximately 0.075%). The formulation also may include water (comprising approximately 79%±5% of the formulation) and sucrose (comprising approximately 20%±5% of the formulation). This ready-to-use formulation may have a specific gravity of approximately 1.10. It should be appreciated that while potassium and sodium bicarbonates may be incorporated into this formulation, other embodiments of this formulation may include only one of the two bicarbonates and/or may include other electrolytes without departing from the present disclosure.

According to another embodiment of the present disclosure, a concentrated hummingbird food formulation may include sodium benzoate (in a range of 0 to 0.10% and more preferably approximately 0.05%), potassium sorbate (in a range of 0 to 0.20% and more preferably approximately 0.10%), citric acid (in a range of 0 to 1.60% and more preferably approximately 0.80%), potassium bicarbonate (in a range of 0 to 0.30% and more preferably approximately 0.15%), and sodium bicarbonate (in a range of 0 to 0.48% and more preferably approximately 0.24%). The formulation also may include water (comprising approximately 38%±5% of the formulation) and sucrose (comprising approximately 62%±5% of the formulation). This concentrated formulation may have a specific gravity of approximately 1.32. This concentrated formulation largely differs from embodiments of the ready-to-use formulation described above insofar as less water and more sucrose may be included in the preparation. Accordingly, more water may be added to the concentrated formulation later at time of use. Further, as described above with respect to embodiments of the ready-to-use formulation, embodiments of the concentrated formulation may be prepared excluding one of the two bicarbonates and/or adding other electrolytes to the formulation without departing from the present disclosure.

Both the ready-to-use and concentrated hummingbird food formulations according to embodiments of the present disclosure may be prepared by forming a premix of approximately 10% of the total UV-distilled water (maintained at or around room temperature), potassium bicarbonate (generally in powder form), sodium bicarbonate (generally in powder form), and at least one preservative such as sodium benzoate and/or potassium sorbate. This premix may be blended until each of the bicarbonates and preservatives have fully dissolved into solution. It should be appreciated that other electrolytes may be included in the premix without departing from the present disclosure. It should be appreciated that one or both of the bicarbonates may be omitted or substituted without departing from the present disclosure.

The remaining UV-distilled water (approximately 90% of the total water incorporated into the formulation) set aside for use in the formulation may then be added into a separate container and heated to a first predetermined temperature of approximately 180-190° Fahrenheit. When the water approaches the above-described approximate temperature range, citric acid may then be added to, and mixed with, this heated water, forming a first mixture.

Upon forming a first mixture, sucrose may then be incrementally added to the first mixture, while continuing to mix at a low-to-medium speed, to form a second mixture. Upon addition of all of the sucrose to the first mixture, this second mixture may be mixed for a period of time such that all of the sucrose may dissolve into solution. When the sucrose has fully dissolved into solution, this second mixture typically may appear cloudy but should not have any apparent crystals.

The second mixture may then be cooled to a second predetermined temperature of approximately 120° Fahrenheit. Upon reaching this approximate second predetermined temperature, the premix may then be added to the second mixture and blended until the premix has dissolved in the second mixture, thereby forming a third mixture.

This third mixture may then be further cooled to a third predetermined temperature of approximately 80° Fahrenheit. Upon cooling the third mixture to this approximate third predetermined temperature, this third mixture should be generally clear in color; however, if particles remain that have not yet dissolved into solution, the third mixture may be blended for additional time at this maintained approximate third predetermined temperature to achieve this clear color.

Various hummingbird food formulations, such as the embodiments of the present disclosure previously described, have been evaluated for their use in reducing dehydration in hummingbirds. More specifically, the impact of diets on electrolyte balance in hummingbirds has been evaluated. In order to evaluate the impact of addition of electrolytes to hummingbird food formulations according to embodiments of the present disclosure, 20 Ruby-Throated Hummingbirds were collected using trap-door feeders erected around an established feeder. These feeders were located in Auburn, Alabama, and the hummingbirds were collected in late June 2010.

The trials addressed the impact of five diets on electrolyte balance in hummingbirds. Each trial lasted approximately two days. During this two-day period, each hummingbird was isolated and offered an experimental diet. The hummingbirds were maintained in outdoor enclosures on a nutritionally complete diet for at least one week between trials.

The experimental diets utilized in the trials conducted are summarized in the chart that follows:

| | | | | | | Electrolyte |
|---|---|---|---|---|---|---|
| | | | | | Cl⁻ | composition |
| | Water | Sucrose | Na⁺ | K⁺ | (mmol/ | comparable |
| Diet | (%) | (%) | (mmol/L) | (mmol/L) | L) | to: |
| A | 85 | 15 | 0 | 0 | 0 | Homemade |
| | | | | | | sugar water |
| | | | | | | & many |
| | | | | | | commercial |
| | | | | | | nectars |
| B | 85 | 15 | 0.9 | 7.2 | 0 | Ocotillo |
| C | 85 | 15 | 3.4 | 24.7 | 9.9 | Average of |
| | | | | | | floral |
| | | | | | | nectars |
| D | 85 | 15 | 35.7 | 12.5 | 0 | Scarlet |
| | | | | | | Hedgenettle |
| E | 85 | 15 | 39.6 | 80.8 | n/a | Fruit flies |

As set forth above, each of the experimental diets included a 15% sucrose and 85% water solution. Three of the experimental diets (B, C, D) were developed to mimic the electrolyte content of flowers commonly visited by hummingbirds. One experimental diet (E) was developed to mimic the electrolyte content of fruit flies, another common food source consumed by hummingbirds. These experimental diets included varying amounts of common electrolytes, and the order that the experimental diets were offered to each hummingbird was randomly determined. The hummingbirds involved in the trials were given an opportunity to acclimate to the experimental diet on the first day of the trials. On the second day, each hummingbird's electrolyte status was quantified based on collection of cloacal fluid from the hummingbird. Based on these trials, introduction of electrolytes into a sucrose/water solution commonly consumed by hummingbirds may lead to better water balance and less dehydration in hummingbirds.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A ready-made electrolyte-enriched hummingbird food formulation comprising:
at least one bicarbonate electrolyte, citric acid, water comprising 74-84% of the formulation, sucrose comprising 15-25% of the formulation, and at least one preservative.

2. The formulation of claim 1 wherein the at least one bicarbonate electrolyte comprises approximately 0.01-0.25% of the formulation.

3. The formulation of claim 1 wherein the at least one bicarbonate electrolyte comprises potassium bicarbonate and sodium bicarbonate.

4. The formulation of claim 3 wherein the at least one preservative comprises sodium benzoate and potassium sorbate.

5. The formulation of claim 1 having a specific gravity of approximately 1.10.

6. A concentrated electrolyte-enriched hummingbird food formulation comprising:
citric acid, water comprising 33-43% of the formulation, sucrose comprising 57-67% of the formulation, and at least one bicarbonate electrolyte.

7. The formulation of claim 6 wherein the at least one bicarbonate electrolyte comprises approximately 0.1-0.8% of the formulation.

8. The formulation of claim 6 further comprising at least one preservative.

9. The formulation of claim 6 wherein the at least one bicarbonate electrolyte comprises potassium bicarbonate and sodium bicarbonate.

10. The formulation of claim 6 wherein the at least one bicarbonate electrolyte is potassium bicarbonate.

11. The formulation of claim 6 wherein the at least one bicarbonate electrolyte is sodium bicarbonate.

12. The formulation of claim 6 having a specific gravity of approximately 1.32.

13. The formulation of claim 6 wherein additional water is added to the formulation at the time of use.

14. A method for improving hummingbird hydration comprising:
forming a premix of water, at least one bicarbonate electrolyte, and at least one preservative, wherein the premix includes approximately 10% of the water comprising the resultant hummingbird food formulation;
heating the remainder of the water comprising the resultant hummingbird food formulation to a first predetermined temperature and then blending with citric acid to form a first mixture;
adding sucrose to the first mixture to form a second mixture;
cooling the second mixture to a second predetermined temperature and adding the premix to the second mixture to form a third mixture; and
cooling the third mixture to a third predetermined temperature, thereby forming the resultant hummingbird food formulation having electrolytes to improve hummingbird hydration.

15. The method of claim 14 wherein the at least one bicarbonate electrolyte is potassium bicarbonate and sodium bicarbonate.

16. The method of claim 14 wherein the premix further comprises at least one non-bicarbonate electrolyte.

17. The method of claim 14 wherein the first predetermined temperature is approximately 180-190 degrees Fahrenheit.

18. The method of claim 14 wherein the second predetermined temperature is approximately 120 degrees Fahrenheit.

19. The method of claim 14 wherein the third predetermined temperature is approximately 80 degrees Fahrenheit.

20. The method of claim 14 wherein the third mixture is clear in color once at the third predetermined temperature.
